(19) United States
(12) Patent Application Publication
(10) Pub. No.: US 2026/0370700 A1
(43) Pub. Date: Nov. 19, 2026

(54) VIDEO CONFERENCE DATA TRANSMISSION SYSTEM AND METHOD

(71) Applicant: YEALINK (XIAMEN) NETWORK TECHNOLOGY CO., LTD., Xiamen (CN)

(72) Inventors: Wanjian FENG, Xiamen (CN); Weiping GONG, Xiamen (CN)

(73) Assignee: YEALINK (XIAMEN) NETWORK TECHNOLOGY CO., LTD., Xiamen (CN)

(21) Appl. No.: 19/563,652

(22) Filed: Mar. 11, 2026

(30) Foreign Application Priority Data
Mar. 11, 2025 (CN) 202510284180.9

(51) Int. Cl. H04L 65/403

(52) U.S. Cl. CPC H04L 65/403

(57) ABSTRACT

A video conference data transmission system and method are provided. The video conference data transmission system includes one or more audio and video data acquisition devices and a local video conference host. Each of the audio and video data acquisition devices is configured to acquire audio and video data. The audio and video data acquisition device is further configured to transmit, through a first network interface, the audio and video data to the local video conference host, where the first network interface is configured to use an encrypted network protocol for data transmission. The local video conference host is configured to transmit, through a second network interface, the audio and video data to a remote video conference host, where the second network interface is configured to use a wide area network protocol for data transmission.

### CROSS-REFERENCE TO RELATED APPLICATION

The present disclosure claims priority to Chinese Patent Application No. 202510284180.9 filed on Mar. 11, 2025, the content of which is incorporated herein by reference in its entirety.

### TECHNICAL FIELD

The present disclosure relates to the technical field of video conference systems, and particularly relates to a video conference data transmission system and method.

### BACKGROUND

A video conference system is a virtual conference system implemented using network communication technologies, in which audio and video data is transmitted over a network to a remote video conference host. In practical implementations, to achieve satisfactory audio and video performance, multiple audio and video data acquisition devices are typically deployed in a local conference room. The audio and video data acquisition devices may include, for example, a camera, a microphone, a loudspeaker, an encoding/decoding device, an audio processing device, and a control device. To achieve uniform sound pickup and broad sound coverage, one or more microphones are typically installed on a ceiling. To save space, maintain an aesthetically pleasing and concealed installation, and keep the setup neat and orderly, a local video conference host and related processing devices are typically as a whole placed in a cabinet. In addition, in view of image capture quality and the participant experience, one or more cameras are typically installed at a corner of a wall, on the ceiling, and at a top end of a display. Accordingly, when deploying video conference devices, the various devices are typically spaced relatively far apart. In addition, different types of audio and video data acquisition devices may be used, and thus the audio and video data acquisition devices are often provided by different suppliers. Different audio and video data acquisition devices provided by different suppliers often use different cables. For example, a camera may use dedicated video cables such as Universal Serial Bus (USB), a network cable, High Definition Multimedia Interface (HDMI), or Digital Visual Interface (DVI); and a microphone and a loudspeaker may use professional audio cables and network cables.

### SUMMARY

In a first aspect, embodiments of the present disclosure provide a video conference data transmission system. The video conference data transmission system includes one or more audio and video data acquisition devices and a local video conference host, where each of the audio and video data acquisition devices is provided with one or more first network interfaces, each of the first network interfaces is electrically connected to the local video conference host, and the local video conference host is provided with a second network interface. Each of the audio and video data acquisition devices is configured to acquire audio and video data. The audio and video data acquisition device is further configured to transmit, through the first network interface, the audio and video data to the local video conference host, where the first network interface is configured to use an encrypted network protocol for data transmission. The local video conference host is configured to transmit, through the second network interface, the audio and video data to a remote video conference host, where the second network interface is configured to use a wide area network protocol for data transmission.

In a second aspect, embodiments of the present disclosure provide a video conference data transmission method for a video conference data transmission system, where the video conference data transmission system includes one or more audio and video data acquisition devices and a local video conference host, each of the audio and video data acquisition devices is provided with one or more first network interfaces, each of the first network interfaces is electrically connected to the local video conference host, and the local video conference host is provided with a second network interface, and where the method includes: Acquiring audio and video data, by each of the audio and video data acquisition devices; transmitting the audio and video data to the local video conference host by the audio and video data acquisition device through the first network interface, where the first network interface is configured to use an encrypted network protocol for data transmission; and transmitting the audio and video data to a remote video conference host by the local video conference host through the second network interface, where the second network interface is configured to use a wide area network protocol for data transmission.

### BRIEF DESCRIPTION OF DRAWINGS

FIG. 1 is a schematic diagram of data transmission of a video conference data transmission system provided by embodiments of the present disclosure.

FIG. 2 is another schematic diagram of data transmission of a video conference data transmission system provided by embodiments of the present disclosure.

FIG. 3 is yet another schematic diagram of data transmission of a video conference data transmission system provided by embodiments of the present disclosure.

FIG. 4 is yet another schematic diagram of data transmission of a video conference data transmission system provided by embodiments of the present disclosure.

FIG. 5 is yet another schematic diagram of data transmission of a video conference data transmission system provided by embodiments of the present disclosure.

FIG. 6 is a schematic diagram of an interaction in which a local video conference host transmits a control command to an audio and video data acquisition device, provided by embodiments of the present disclosure.

FIG. 7 is another schematic diagram of an interaction in which a local video conference host transmits a control command to an audio and video data acquisition device, provided by embodiments of the present disclosure.

FIG. 8 is a flowchart of a video conference data transmission method provided by embodiments of the present disclosure.

### DETAILED DESCRIPTION

The present disclosure will be described in detail below through embodiments.

A video conference system is a virtual conference system implemented through network communication technology, that is, transmitting audio and video data through a network to a remote video conference host. In actual applications, to achieve good audio and video performance, it is usually necessary to arrange multiple audio and video data acquisition devices in a local conference room, where the audio and video data acquisition devices may include a camera, a microphone, a loudspeaker, an encoding and decoding device, an audio processing device, and a control device, etc.

Further, to achieve uniform sound pickup and broad sound coverage, one or more microphones are typically installed on a ceiling. To save space, maintain an aesthetically pleasing and concealed installation, and keep the setup neat and orderly, the local video conference host and related processing devices are typically as a whole placed in a cabinet. In addition, in view of image capture quality and the participant experience, one or more cameras are typically installed at a corner of a wall, on the ceiling, and at a top end of a display. Accordingly, when deploying video conference devices, the various devices are typically spaced relatively far apart.

In addition, different types of audio and video data acquisition devices are used, and thus the audio and video data acquisition devices are often provided by different suppliers. Different audio and video data acquisition devices provided by different suppliers often use different cables. For example, a camera may use dedicated video cables such as Universal Serial Bus (USB), a network cable, High Definition Multimedia Interface (HDMI), or Digital Visual Interface (DVI); and a microphone and a loudspeaker may use professional audio cables and network cables. The related art directly applies connection logic and general interface protocols designed for an open, complex, and routing-variable wide area network environment to a conference room, which is a closed and controllable proprietary space having a fixed physical topology and very high internal data security requirements. This results in a mismatch between technical means and scenario requirements: on the one hand, to achieve device compatibility, a host has to integrate multiple general-purpose physical interfaces (e.g., USB and HDMI), leading to increased structural complexity and wasted resources; on the other hand, these general interface protocols, at the outset, did not treat end-to-end strong encryption and simplified dedicated wiring for internal data transmission in a conference room as core requirements, such that, while the system pursues connection convenience, it sacrifices fundamental security and deployment economy.

It can be seen from the above that, due to the diversity of audio and video data acquisition devices and the need to place such devices at certain locations within a conference room, there are issues of device compatibility, security, and wiring cost. Professional audio and video cabling is costly and typically limited in length. Accordingly, audio and video data from the audio and video data acquisition devices are uniformly transmitted between a local video conference host and a remote video conference host. This, in turn, requires the local video conference host to be compatible with audio and video data acquisition devices having many different interfaces, resulting in the local video conference host needing to provide many interfaces. Further, to accommodate different suppliers, non-standard interfaces may be used for data transmission, which can lead to low audio and video data security. Therefore, the inventor recognized that the key is not to continuously add interface types at the host side to passively accommodate devices, but rather to proactively define and establish an independent and scenario-self-consistent communication architecture for the specific scenario of local device interconnection in a conference room. A core objective of this architecture is that, in a closed environment, standardized physical media (e.g., network cables) and an embedded encryption protocol are used to construct a secure, simple, and efficient dedicated data transmission channel, thereby transforming device interconnection from a general, open compatibility challenge into a dedicated, closed-channel reliability assurance issue.

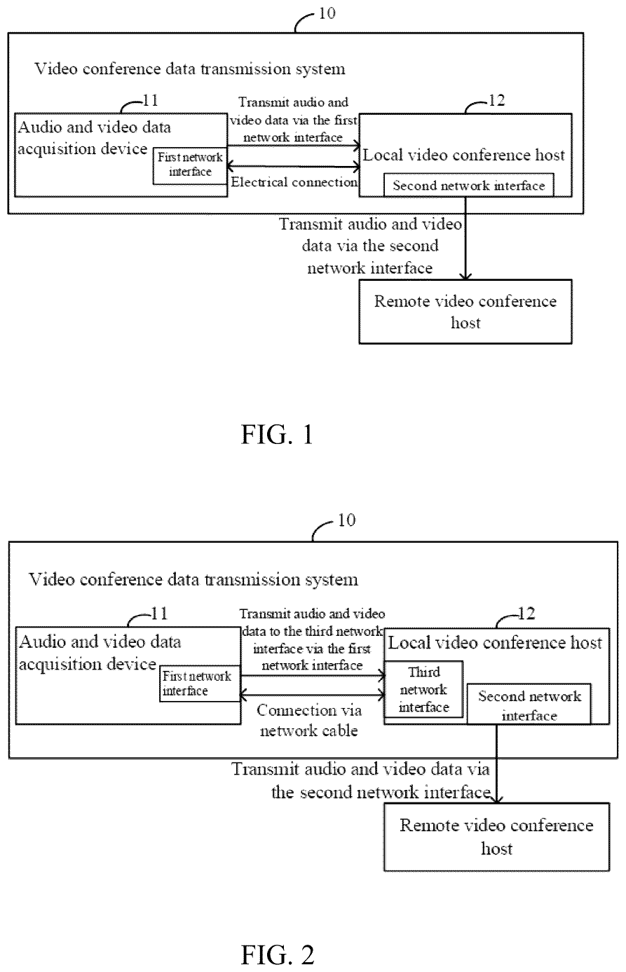

In a first aspect, a video conference data transmission system according to embodiments of the present disclosure is described in detail below. As shown in FIG. 1, a video conference data transmission system 10 according to embodiments of the present disclosure may include one or more audio and video data acquisition devices 11 and a local video conference host 12. The audio and video data acquisition device 11 is provided with a first network interface. The first network interface is in communication with the local video conference host 12, and the local video conference host 12 is provided with a second network interface.

The audio and video data acquisition device 11 acquires audio and video data.

The audio and video data acquisition device 11 transmits the audio and video data to the local video conference host through the first network interface, where the first network interface uses an encrypted network protocol for data transmission.

The local video conference host 12 transmits the audio and video data to a remote video conference host through the second network interface, where the second network interface uses a wide area network protocol for data transmission.

Specifically, the audio and video data acquisition devices may be divided into two types, namely, an audio acquisition device and a video acquisition device. The audio acquisition device may be a microphone for acquiring an audio signal. In practical implementations, the number of microphones may be one or more. The video acquisition device may be a camera for acquiring a video signal. In practical implementations, the number of cameras may likewise be one or more.

After the one or more audio and video data acquisition devices acquire the audio and video data, the audio and video data may be encrypted and encapsulated using a customized encrypted network protocol of the first network interface, thereby obtaining encrypted-encapsulated audio and video data. The encrypted-encapsulated audio and video data is then transmitted to the local video conference host through the first network interface, thereby achieving transmission of the encrypted-encapsulated audio and video data within the local conference room. Further, because the first network interface uses the customized encrypted network protocol for data transmission and does not route over the wide area network, malicious attacks from an external network can be prevented and leakage of the audio and video data can be avoided.

After the local video conference host receives the audio and video data transmitted by the audio and video data acquisition device through the first network interface, the received audio and video data may be decrypted and de-encapsulated, and the audio and video data is then transmitted to the remote video conference host through the second network interface. Because the second network interface uses the wide area network protocol for data transmission, it can ensure that the audio and video data is accurately transmitted between different networks.

It can be seen from the foregoing that audio and video data transmission is performed using two different networks: one within the local conference room and another between the local video conference host and the remote video conference host. This is because the internal network environment of an independent conference room is relatively closed and stable, the number of devices is limited, and management is centralized. Accordingly, the first network interface (i.e., a customized encrypted network interface) can avoid interference from an external network, reduce occurrences of data loss and data errors during audio and video data transmission, and ensure stable transmission of the audio and video data. In addition, an encryption algorithm may be used to prevent malicious attacks and data leakage from an external network. Further, the audio and video data may be transmitted directly at a data link layer, which can reduce latency during audio and video data transmission and improve transmission efficiency of the audio and video data.

The video conference data transmission system according to embodiments of the present disclosure includes the one or more audio and video data acquisition devices and a local video conference host. The audio and video data acquisition device and the local video conference host are internal devices of the local conference room. Audio and video data is transmitted among the internal devices through the first network interface, instead of using USB cables and professional audio and video cables, thereby reducing the number of interfaces of the local video conference host, such that audio and video data is transmitted among the internal devices using network cables. Further, the first network interface uses an encrypted network protocol for data transmission, which can prevent malicious attacks from an external network and leakage of the audio and video data. The local video conference host uniformly transmits the audio and video data to an external remote video conference host through the second network interface, and since the second network interface uses a wide area network protocol for data transmission, it can ensure that the audio and video data is accurately transmitted between different networks.

In some embodiments, based on the embodiments shown in FIG. 1, the local video conference host is further provided with a third network interface. The third network interface uses an encrypted network protocol for data transmission, and the first network interface and the third network interface are connected via a network cable.

As shown in FIG. 2, the audio and video data acquisition device is provided with one type of interface, namely the first network interface. The local video conference host 12 is provided with two types of interfaces, namely, the second network interface and the third network interface, where the second network interface is used for data transmission with the remote video conference host. The third network interface uses the encrypted network protocol for data transmission. That is, the third network interface is of the same type as the first network interface, and the third network interface is used for data transmission with the first network interface.

At this time, the transmitting, by the audio and video data acquisition device through the first network interface, the audio and video data to the local video conference host may include the following:
performing, by the audio and video data acquisition device, encrypted encapsulation on the audio and video data using an encrypted network protocol of the first network interface to obtain encrypted-encapsulated audio and video data.

The audio and video data acquisition device transmits, through the first network interface, the encrypted-encapsulated audio and video data to the third network interface.

Correspondingly, the transmitting, by the local video conference host through the second network interface, the audio and video data to the remote video conference host may include the following:
decrypting and de-encapsulating, by the local video conference host, the encrypted-encapsulated audio and video data using a decryption and de-encapsulation mode corresponding to the encrypted network protocol, and transmitting, through the second network interface, the decrypted and de-encapsulated audio and video data to the remote video conference host.

For example, after the audio and video data acquisition device acquires audio and video data, the audio and video data acquisition device encrypts the audio and video data through a data encryption module of the audio and video data acquisition device according to a customized encrypted network protocol, thereby obtaining encrypted audio and video data; the audio and video data acquisition device encapsulates the encrypted audio and video data through the first network interface to obtain encrypted-encapsulated audio and video data; and the audio and video data acquisition device transmits, through the first network interface, the encrypted-encapsulated audio and video data to the third network interface.

After the third network interface receives the encrypted-encapsulated audio and video data, the encrypted-encapsulated audio and video data is de-encapsulated to obtain de-encapsulated encrypted audio and video data. The de-encapsulated encrypted audio and video data is decrypted through an audio and video data processing module of the local video conference host to obtain decrypted and de-encapsulated audio and video data. The decrypted and de-encapsulated audio and video data is re-encapsulated through the second network interface according to a wide area network protocol, and the re-encapsulated audio and video data is transmitted to the remote video conference host.

In the embodiments, by providing the first network interface for the audio and video data acquisition device and configuring the audio and video data acquisition device to perform encrypted encapsulation on acquired audio and video data using an encrypted network protocol and then transmit the audio and video data to the local video conference host, an existing approach that relies on multiple types of physical cables for data transmission is replaced. As a result, internal device connections within the conference room are unified as standard network cables, thereby greatly simplifying the wiring system and reducing deployment cost. In addition, the local video conference host communicates with the remote end through the second network interface using a wide area network protocol. When the host is further configured with the third network interface that uses the same encrypted network protocol with the first network interface, the third network interface is directly connected to the first network interface through a network cable, thereby forming an independently operating encrypted transmission subnet within the conference room. This subnet is isolated from an external wide area network at the physical and protocol layers, and data transmitted within the subnet remains in a ciphertext state from the time it leaves the acquisition device, thereby effectively preventing risks that the data is intercepted or tampered with on internal lines. Further, since the encryption transmission mechanism of the first network interface cooperates with a dual-network-interface architecture at the host side, local audio and video data streams can be transmitted directly to a local processing unit of the host through a dedicated encrypted channel, avoiding competing for bandwidth with external network traffic or sharing a complex protocol stack. Accordingly, while achieving low-latency and high-stability internal data transmission, an efficient approach is provided for the host to centrally perform processing such as data decryption, format conversion, and wide area network packet transmitting. On one hand, compatibility and reliability of interconnection with the remote video conference system are ensured; on the other hand, integration, security, and maintainability of the entire conference system are improved through unification of physical interfaces and encryption during transmission.

It can be seen that internal devices of a local conference room perform data transmission through the first network interface, and thus USB cables and professional audio and video cables are replaced with network cables. While reducing the number of interfaces of the local video conference host, this also simplifies the wiring system and reduces cost. The first network interface uses the encrypted network protocol for data transmission, which can prevent malicious attacks from an external network and leakage of the audio and video data. The local video conference host uniformly transmits the audio and video data to an external remote video conference host through the second network interface using a wide area network protocol, which can ensure accurate transmission of the audio and video data between different networks, thereby forming a video conference data transmission system in which internal and external networks are separated and which is secure and efficient.

Further, the local video conference host may also transmit the audio and video data to a local terminal for playback through an audio and video output interface of the local video conference host itself. For example, the local terminal may be a television, etc., for playing the audio and video data.

Based on the embodiments shown in FIG. 1, in some embodiments, the local video conference host is further provided with a first USB interface. The video conference data transmission system further includes a bridge device. The bridge device is provided with a fourth network interface. The fourth network interface uses an encrypted network protocol for data transmission. The first network interface and the fourth network interface are connected through a network cable. The bridge device is provided with a second USB interface, and the first USB interface and the second USB interface are connected through a USB cable.

In practical implementations, the local video conference host may also be a personal computer on which video conference software is installed. The video conference software is a software system integrating real-time audio and video communication, data collaboration, conference management, and security control functions, and connects participants distributed at different locations into the same virtual space through a network to support remote collaboration and communication, which is not specifically limited herein. If the local video conference host is a personal computer, two types of interfaces of the local video conference host are respectively a USB interface and the second network interface. In this case, because the local video conference host does not have a network interface for directly performing data transmission with the first network interface, the audio and video data acquisition device indirectly performs data transmission with the local video conference host through the bridge device via the first network interface.

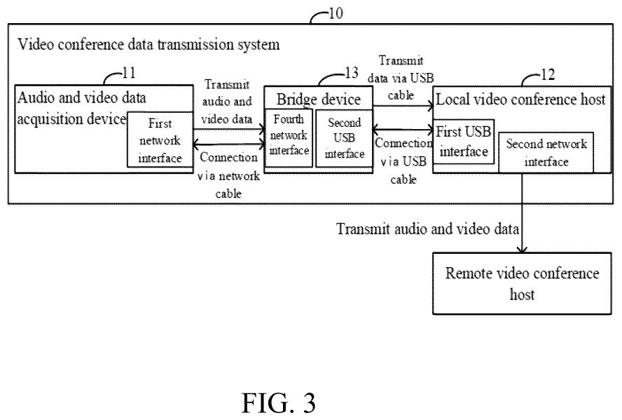

As shown in FIG. 3, the audio and video data acquisition device 11 is provided with one type of interface, namely the first network interface. The local video conference host 12 is provided with two types of interfaces, namely a USB interface and the second network interface. The video conference data transmission system further includes a bridge device 13. The bridge device is provided with a fourth network interface, and the fourth network interface is used for data transmission with the first network interface. A second USB interface of the bridge device and a first USB interface of the local video conference host are connected through a USB cable. The bridge device can convert audio and video data into USB-protocol-encapsulated audio and video data and transmit the USB-protocol-encapsulated audio and video data to the local video conference host. The second network interface of the local video conference host is used for data transmission with the remote video conference host.

At this time, the transmitting, by the audio and video data acquisition device through the first network interface, the audio and video data to the local video conference host may include the following:
performing, by the audio and video data acquisition device, encrypted encapsulation on the audio and video data using an encrypted network protocol of the first network interface, and transmitting, through the first network interface, the encrypted-encapsulated audio and video data to the fourth network interface.

The bridge device re-encapsulates the encrypted-encapsulated audio and video data using a USB protocol to obtain USB-protocol-encapsulated encrypted audio and video data, and transmits, through the second USB interface, the USB-protocol-encapsulated encrypted audio and video data to the first USB interface.

Correspondingly, the transmitting, by the local video conference host through the second network interface, the audio and video data to the remote video conference host may include the operations of:
decrypting and de-encapsulating, by the local video conference host, the USB-protocol-encapsulated encrypted audio and video data, and transmitting, through the second network interface, the decrypted and de-encapsulated audio and video data to the remote video conference host.

For example, in the embodiments, the local video conference host is not provided with a third network interface, but is provided with a USB interface. In this case, the audio and video data acquisition device can indirectly transmit audio and video data to the local video conference host through the bridge device. That is, the audio and video data acquisition device can first transmit, through the first network interface, encrypted-encapsulated audio and video data to the fourth network interface of the bridge device; the bridge device re-encapsulates the encrypted-encapsulated audio and video data to obtain USB-protocol-encapsulated encrypted audio and video data; and the bridge device then transmits, through the second USB interface and via the USB cable, the USB-protocol-encapsulated encrypted audio and video data to the first USB interface of the local video conference host.

After the local video conference host receives the USB-protocol-encapsulated encrypted audio and video data, the local video conference host can decrypt and de-encapsulate the received USB-protocol-encapsulated encrypted audio and video data, and transmit the audio and video data to the remote video conference host through the second network interface. Because the second network interface uses a wide area network protocol for data transmission, it can ensure that the audio and video data is accurately transmitted between different networks.

It can be seen that internal devices of the local conference room perform data transmission through the first network interface, which can reduce the number of interfaces of the local video conference host. Further, the first network interface uses an encrypted network protocol for data transmission, which can prevent malicious attacks from an external network and leakage of the audio and video data. The local video conference host uniformly transmits the audio and video data to an external remote video conference host through the second network interface using a wide area network protocol, which can ensure accurate transmission of the audio and video data between different networks.

In addition, the bridge device may also first decode the audio and video data and then encode the audio and video data into an audio and video format compatible with the video conference software of the local video conference host. For example, the audio and video data may be encoded into data in an MJPEG format, and then the data in the MJPEG format may be encapsulated into data of a USB protocol and transmitted to the local video conference host. Whether the bridge device decodes and then encodes the audio and video data mainly depends on compatibility of the video conference software being used. For example, if the video conference software is third-party video conference software and does not support audio and video data in an H.264 format but supports audio and video data in an MJPEG format, then the audio and video data in the H.264 format may be decoded and then encoded into audio and video data in an MJPEG format, and the audio and video data in the MJPEG format may be transmitted to the local video conference host.

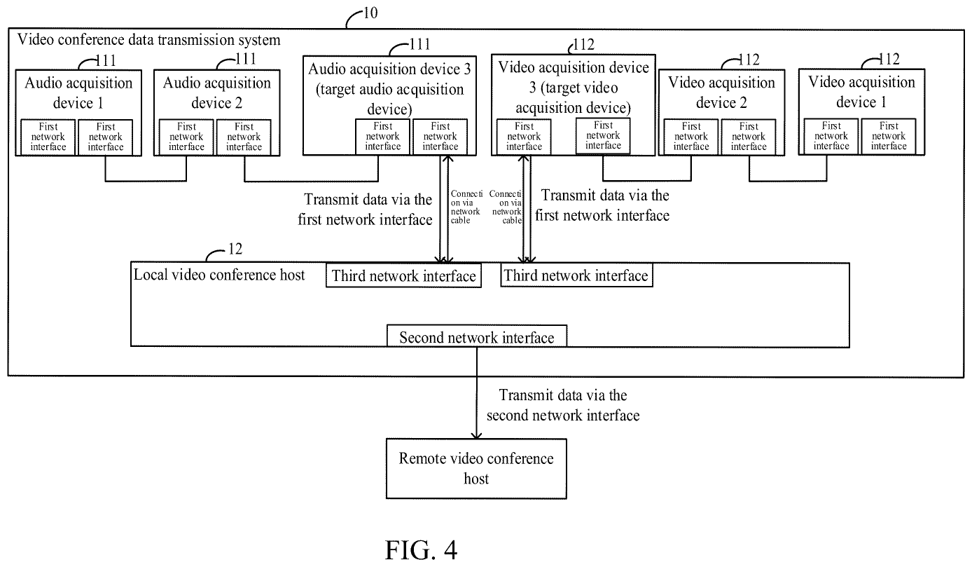

Based on the embodiments shown in FIG. 2, in some embodiments, as shown in FIG. 4, the one or more audio and video data acquisition devices include one or more video acquisition devices 111 and one or more audio acquisition devices 112. Multiple video acquisition devices and multiple audio acquisition devices may be provided, where one video acquisition device is used as a target video acquisition device, and one audio acquisition device is used as a target audio acquisition device. Each video acquisition device is provided with multiple first network interfaces, and each audio acquisition device is provided with multiple first network interfaces. The video acquisition devices are cascaded through the first network interface, and the audio acquisition devices are cascaded through the first network interface.

At this time, the transmitting, by the audio and video data acquisition device through the first network interface, the encrypted-encapsulated audio and video data to the third network interface may include the following:
obtaining, by the target video acquisition device, through cascading, encrypted-encapsulated video data of the video acquisition devices, and transmitting, through the first network interface, the obtained encrypted-encapsulated video data to the third network interface; and
obtaining, by the target audio acquisition device, through cascading, encrypted-encapsulated audio data of the audio acquisition devices, and transmitting, through the first network interface, the obtained encrypted-encapsulated audio data to the third network interface.

For example, if there are multiple video acquisition devices and multiple audio acquisition devices, and each video acquisition device includes multiple first network interfaces, and each audio acquisition device also includes multiple first network interfaces, and the local video conference host also includes multiple third network interfaces, then the video acquisition devices can be cascaded through the first network interfaces, and the audio acquisition devices can also be cascaded through the first network interface. As shown in FIG. 4, taking a case where there are three video acquisition devices as an example, namely video acquisition device 1, video acquisition device 2, and video acquisition device 3, each of the three video acquisition devices may be provided with two first network interfaces. One first network interface of the video acquisition device 1 is connected to one first network interface of the video acquisition device 2, and the other first network interface of the video acquisition device 2 is connected to one first network interface of the video acquisition device 3, thereby achieving cascading of the video acquisition device 1, the video acquisition device 2, and the video acquisition device 3. The other first network interface of the video acquisition device 3 is connected to one third network interface of the local video conference host. The video acquisition device 3 is regarded as the target video acquisition device. The video acquisition device 3 can obtain encrypted-encapsulated video data of the video acquisition device 1, the video acquisition device 2, and the video acquisition device 3 itself, and transmit, through the first network interface, the obtained encrypted-encapsulated video data to the third network interface of the local video conference host.

It can be seen that by cascading of the video acquisition devices, the target video acquisition device can transmit encrypted-encapsulated video data of the video acquisition devices to the local video conference host.

As shown in FIG. 4, similarly, taking a case where there are three audio acquisition devices as an example, namely audio acquisition device 1, audio acquisition device 2, and audio acquisition device 3, each of the three audio acquisition devices may be provided with two first network interfaces. One first network interface of the audio acquisition device 1 is connected to one first network interface of the audio acquisition device 2, and the other first network interface of the audio acquisition device 2 is connected to one first network interface of the audio acquisition device 3, thereby achieving cascading of the audio acquisition device 1, the audio acquisition device 2, and the audio acquisition device 3. The other first network interface of the audio acquisition device 3 is connected to another third network interface of the local video conference host. The audio acquisition device 3 is regarded as the target audio acquisition device. The audio acquisition device 3 can obtain encrypted-encapsulated audio data of the audio acquisition device 1, the audio acquisition device 2, and the audio acquisition device 3 itself, and transmit, through the first network interface, the obtained encrypted-encapsulated audio data to another third network interface of the local video conference host.

It can be seen that by cascading of the audio acquisition devices, the target audio acquisition device can transmit, through the first network interface, encrypted-encapsulated audio data of the audio acquisition devices to the local video conference host.

Specifically, as shown in FIG. 4, the video acquisition devices 111 and the audio acquisition devices 112 are cascaded in a daisy-chaining or similar manner through multiple first network interfaces of each device itself. In the video conference system of the embodiment, one video acquisition device is designated as the target video acquisition device, and one audio acquisition device is designated as the target audio acquisition device. After each device acquires data and completes local encrypted encapsulation, the device not only transmits its own data but also aggregates and forwards encrypted data from an upper-stage device. With this cascading design, only one first network interface of the target video acquisition device and one first network interface of the target audio acquisition device are needed to aggregate and transmit encrypted data streams of all same-type acquisition devices in the entire conference room to the local video conference host. For example, after the video acquisition devices 1, 2, and 3 are cascaded, only one uplink interface of the video acquisition device 3 (as the target device) needs to be connected to the host, thereby completing data aggregation and uploading of the three devices. Thus, while maintaining the advantages of unified encrypted transmission via the first network interface, the scheme further achieves significant simplification of physical wiring. Multiple acquisition devices in the conference room no longer need separate dedicated network cables routed directly to the host; instead, the number of trunk cables can be greatly reduced through cascading of nearby devices, thereby reducing wiring complexity and construction cost. Meanwhile, because all data transmission along the cascading path is protected by the encryption protocol, the system's security does not decrease due to changes in topology. As a result, scalability and deployment flexibility of the entire video conference system are enhanced. When acquisition devices are added or adjusted, it is only necessary to connect them to a nearby cascading node without re-planning host-side cables and interfaces, thereby making the system easier to maintain and expand.

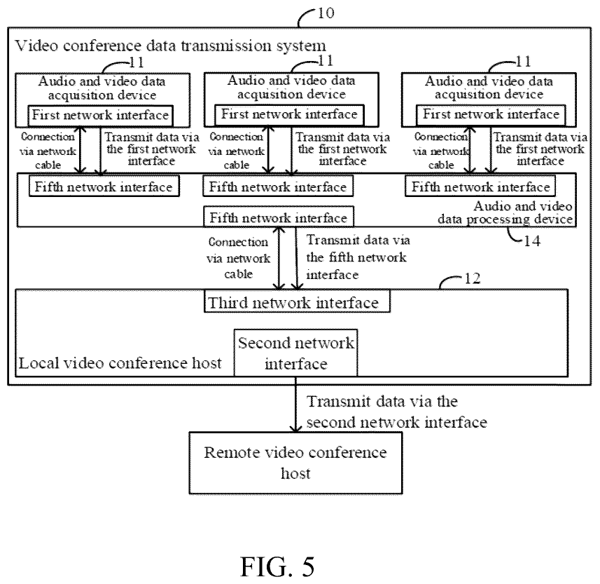

Based on the embodiments shown in FIG. 2, in some embodiments, there are multiple audio and video data acquisition devices 11. As shown in FIG. 5, the video conference data transmission system 10 further includes an audio and video data processing device 14. The audio and video data processing device is provided with multiple fifth network interfaces, and the fifth network interfaces all use an encrypted network protocol for data transmission. That is, the fifth network interfaces and the first network interface are interfaces of the same type. The audio and video data processing device may be an Ethernet switch or an audio and video hub device.

At this time, the transmitting, by multiple audio and video data acquisition devices through the first network interface, the encrypted-encapsulated audio and video data to the third network interface may include the following:
transmitting, by the audio and video data acquisition devices via their respective first network interfaces, the encrypted-encapsulated audio and video data to fifth network interfaces of the audio and video data processing device;
performing, by the audio and video data processing device, data processing on the received encrypted-encapsulated audio and video data to obtain audio and video data after data processing; and
transmitting, by the audio and video data processing device via its fifth network interface, the audio and video data after data processing to the third network interface of the local video conference host.

For example, if the audio and video data processing device is an audio and video hub device, the audio and video hub device can access multiple different audio and video data sources for connection and data source management among the audio and video data devices. That is, the audio and video hub device receives the audio and video data sent by multiple audio and video data acquisition devices through the first network interface, and can perform data processing on the audio and video data. The data processing may include, for example, format conversion, audio and video data source switching, audio and video data source allocation, audio and video data synthesis, etc. If the audio and video data processing device is an Ethernet switch, the Ethernet switch is mainly used for data exchange among multiple audio and video acquisition devices in a local area network, and forwards the audio and video data to the local video conference host according to a media access control (MAC) address to improve data transmission efficiency in the local area network.

Based on the embodiments shown in FIG. 2, FIG. 4, and FIG. 5, in some embodiments, the local video conference host can perform encrypted encapsulation on a control command using an encrypted network protocol of the third network interface, and transmit, through the third network interface, the encrypted-encapsulated control command to the first network interface of the audio and video data acquisition device. The audio and video data acquisition device decrypts and de-encapsulates the encrypted-encapsulated control command using a decryption and de-encapsulation mode corresponding to the encrypted network protocol, thereby obtaining a decrypted and de-encapsulated control command. Then, a processor of the audio and video data acquisition device responds to the decrypted and de-encapsulated control command to perform corresponding control on itself. For example, a steering of the audio and video data acquisition device can be adjusted, and a size of an image acquired by the audio and video acquisition device can also be adjusted, which is not specifically limited in embodiments of the present disclosure.

Based on the embodiment shown in FIG. 3, the local video conference host can also transmit a control command to the audio and video data acquisition device to control the audio and video data acquisition device.

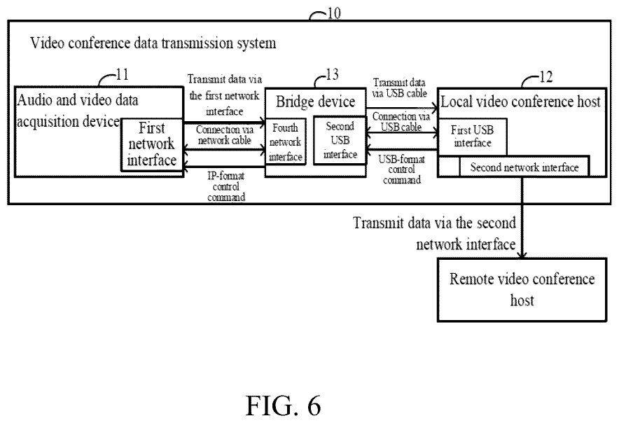

For example, based on the embodiment shown in FIG. 3, as shown in FIG. 6, in some embodiments, the local video conference host 12 transmits, through a first USB interface, a USB-protocol-encapsulated control command to a second USB interface of a bridge device 13. The bridge device re-encapsulates the USB-protocol-encapsulated control command using an encrypted network protocol to obtain an encrypted-encapsulated control command, and transmits, through a fourth network interface, the encrypted-encapsulated control command to the first network interface of a corresponding audio and video data acquisition device. The audio and video data acquisition device decrypts and de-encapsulates the encrypted-encapsulated control command to obtain a decrypted and de-encapsulated control command, and responds to the decrypted and de-encapsulated control command to perform corresponding control on itself.

In the embodiment, the local video conference host can transmit the USB-protocol-encapsulated control command to the bridge device, which may be referred to as a USB-format control command. The bridge device re-encapsulates the USB-protocol-encapsulated control command using the encrypted network protocol of the fourth network interface to obtain an encrypted-encapsulated control command, which may be referred to as an Internet Protocol (IP) format control command, and transmits the encrypted-encapsulated control command to the audio and video data acquisition device. The audio and video data acquisition device decrypts and de-encapsulates the encrypted-encapsulated control command to obtain a decrypted and de-encapsulated control command, and performs corresponding control on the audio and video data acquisition device, for example, controlling steering of the audio and video data acquisition device and adjusting a size of the image acquired by the audio and video acquisition device.

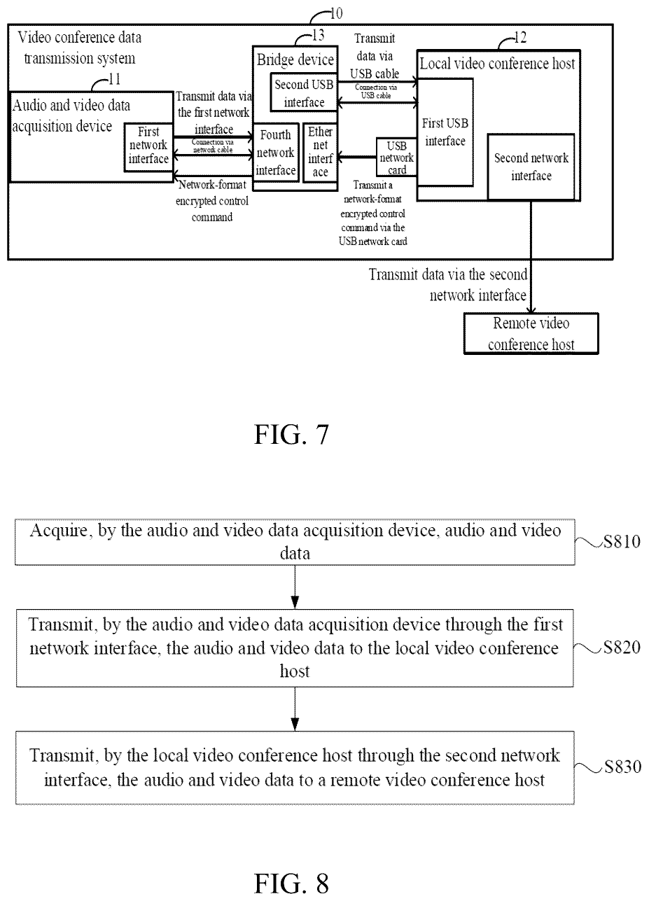

Based on the embodiment shown in FIG. 3, in other embodiments, as shown in FIG. 7, the bridge device is further provided with an Ethernet interface. The local video conference host is connected to a USB network card through the first USB interface, and the USB network card is electrically connected to the Ethernet interface. That is, a USB network card is inserted into the first USB interface, such that the local video conference host obtains network access and is thereby capable of transmitting a network-format control command to the Ethernet interface of the bridge device.

At this time, the local video conference host transmits a network-format encrypted control command to the Ethernet interface of the bridge device through the USB network card, and the network-format encrypted control command may also be referred to as an IP-format encrypted control command. The bridge device transmits, through the fourth network interface, the network-format encrypted control command to the audio and video data acquisition device. The audio and video data acquisition device decrypts and de-encapsulates the network-format control command to obtain a decrypted and de-encapsulated control command, and responds to the decrypted and de-encapsulated control command to perform corresponding control on itself.

In the embodiment, the local video conference host can transmit a network-format-encapsulated encrypted control command to the Ethernet interface of the bridge device. In this case, the bridge device does not need to re-encapsulate the control command. Instead, the bridge device directly transmits the network-format encrypted control command to the audio and video data acquisition device. The audio and video data acquisition device decrypts and de-encapsulates the network-format control command to obtain a decrypted and de-encapsulated control command, and performs corresponding control on the audio and video data acquisition device, for example, controlling steering of the audio and video data acquisition device and adjusting a size of the image acquired by the audio and video acquisition device.

Embodiments of the present disclosure further provide a video conference data transmission method for a video conference data transmission system. The video conference data transmission system includes one or more audio and video data acquisition devices and a local video conference host. Each audio and video data acquisition device is provided with one or more first network interfaces, and the first network interface is electrically connected to the local video conference host. The local video conference host is provided with a second network interface. As shown in FIG. 8, the method may include the following:
In S810, each audio and video data acquisition device acquires audio and video data.
In S820, the audio and video data acquisition device transmits, through the first network interface, the audio and video data to the local video conference host.

The first network interface is configured to use an encrypted network protocol for data transmission.
In S830, the local video conference host transmits, through a second network interface, the audio and video data to a remote video conference host.

The second network interface is configured to use a wide area network protocol for data transmission.

After the audio and video data acquisition device acquires the audio and video data, the audio and video data can be encrypted and encapsulated using a customized encrypted network protocol of the first network interface, thereby obtaining encrypted-encapsulated audio and video data. The encrypted-encapsulated audio and video data is then transmitted to the local video conference host through the first network interface, thereby achieving transmission of the encrypted-encapsulated audio and video data within the local conference room. Further, the first network interface uses the customized encrypted network protocol for data transmission and does not route over the wide area network, so malicious attacks from an external network can be prevented and leakage of the audio and video data can be prevented.

After the local video conference host receives the audio and video data transmitted by the audio and video data acquisition device through the first network interface, the received audio and video data may be decrypted and de-encapsulated, and the audio and video data is then transmitted to the remote video conference host through the second network interface. Since the second network interface uses a wide area network protocol for data transmission, it can ensure that the audio and video data is accurately transmitted between different networks.

The video conference data transmission system according to embodiments of the present disclosure includes one or more audio and video data acquisition devices and a local video conference host. The audio and video data acquisition device and the local video conference host are internal devices of the local conference room. Audio and video data is transmitted among the internal devices through the first network interface, instead of using USB cables and professional audio and video cables, thereby reducing the number of interfaces of the local video conference host, such that audio and video data is transmitted among the internal devices using network cables. Further, the first network interface uses an encrypted network protocol for data transmission, which can prevent malicious attacks from an external network and leakage of the audio and video data. The local video conference host uniformly transmits the audio and video data to an external remote video conference host through the second network interface, and since the second network interface uses a wide area network protocol for data transmission, it can ensure that the audio and video data is accurately transmitted between different networks.

The video conference data transmission method according to embodiments of the present disclosure corresponds to the video conference data transmission system. Accordingly, other content of the video conference data transmission method will not be described in detail herein, and reference may be made to the corresponding content of the video conference data transmission system.

Although embodiments of the present disclosure have been shown and described above, it can be understood that the above embodiments are exemplary and are not to be construed as limitations of the present disclosure. A person of ordinary skill in the art may make changes, modifications, substitutions, and variations to the above embodiments within the scope of the present disclosure without departing from the principles and spirit of the present disclosure.

What is claimed is:

1. A video conference data transmission system, comprising one or more audio and video data acquisition devices and a local video conference host, wherein each of the audio and video data acquisition devices is provided with one or more first network interfaces, each of the first network interfaces is electrically connected to the local video conference host, and the local video conference host is provided with a second network interface;
wherein each of the audio and video data acquisition devices is configured to acquire audio and video data;
the audio and video data acquisition device is further configured to transmit, through the first network interface, the audio and video data to the local video conference host, wherein the first network interface is configured to use an encrypted network protocol for data transmission; and
the local video conference host is configured to transmit, through the second network interface, the audio and video data to a remote video conference host, wherein the second network interface is configured to use a wide area network protocol for data transmission.

2. The system according to claim 1, wherein the local video conference host is further provided with one or more third network interfaces, each of the third network interfaces is configured to use the encrypted network protocol for data transmission, and the third network interface is configured to be connected to a respective first network interface through a network cable;
each of the audio and video data acquisition devices is further configured to perform encrypted encapsulation on the audio and video data through the encrypted network protocol of the first network interface to obtain encrypted-encapsulated audio and video data, and transmit, through the first network interface, the encrypted-encapsulated audio and video data to the third network interface.

3. The system according to claim 2, wherein the local video conference host is further configured to decrypt and de-encapsulate the encrypted-encapsulated audio and video data by using a decryption and de-encapsulation mode corresponding to the encrypted network protocol, and transmit, through the second network interface, decrypted and de-encapsulated audio and video data to the remote video conference host.

4. The system according to claim 2, wherein the audio and video data acquisition devices comprise a plurality of video acquisition devices and a plurality of audio acquisition devices, one of the video acquisition devices is designated as a target video acquisition device, and one of the audio acquisition devices is designated as a target audio acquisition device; the video acquisition devices are cascaded through the first network interfaces of the video acquisition devices, and the audio acquisition devices are cascaded through the first network interfaces of the audio acquisition devices;
the target video acquisition device is configured to obtain, through the cascaded video acquisition devices, encrypted-encapsulated video data of the cascaded video acquisition devices, and transmit, through a first network interface of the target video acquisition device, obtained encrypted-encapsulated video data to a respective third network interface; and
the target audio acquisition device is configured to obtain, through the cascaded audio acquisition devices, encrypted-encapsulated audio data of the cascaded audio acquisition devices, and transmit, through a first network interface of the target audio acquisition device, obtained encrypted-encapsulated audio data to a respective third network interface.

5. The system according to claim 2, wherein the video conference data transmission system comprises a plurality of audio and video data acquisition devices; the video conference data transmission system further comprises an audio and video data processing device, the audio and video data processing device is provided with a plurality of fifth network interfaces, and the fifth network interfaces are configured to use the encrypted network protocol for data transmission;
each of the audio and video data acquisition devices is configured to transmit, through the first network interface, the encrypted-encapsulated audio and video data to a respective fifth network interface; and
the audio and video data processing device is configured to perform data processing on the received encrypted-encapsulated audio and video data to obtain audio and video data after data processing; and transmit, through a respective one of the fifth network interfaces, the audio and video data after data processing to the third network interface.

6. The system according to claim 5, wherein the audio and video data processing device is an Ethernet switch or an audio and video hub device.

7. The system according to claim 1, wherein the video conference data transmission system further comprises a bridge device, and the bridge device is provided with a fourth network interface; the fourth network interface is configured to use the encrypted network protocol for data transmission, and the fourth network interface is connected to the first network interface of a respective audio and video data acquisition device through a network cable; the local video conference host is provided with a first USB interface, the bridge device is provided with a second USB interface, and the first USB interface and the second USB interface are configured to be connected through a USB cable;
each of the audio and video data acquisition devices is further configured to perform encrypted encapsulation on the audio and video data through the encrypted network protocol of the first network interface, and transmit, through the first network interface, encrypted-encapsulated audio and video data to the fourth network interface; and
the bridge device is configured to re-encapsulate the encrypted-encapsulated audio and video data through a USB protocol to obtain USB-protocol-encapsulated encrypted audio and video data, and transmit, through the second USB interface, the USB-protocol-encapsulated encrypted audio and video data to the first USB interface.

8. The system according to claim 7, wherein the local video conference host is further configured to decrypt and de-encapsulate the USB-protocol-encapsulated encrypted audio and video data, and transmit, through the second network interface, decrypted and de-encapsulated audio and video data to the remote video conference host.

9. The system according to claim 7, wherein the local video conference host is further configured to transmit, through the first USB interface, a USB-protocol-encapsulated control command to the second USB interface;
the bridge device is further configured to re-encapsulate the USB-protocol-encapsulated control command through the encrypted network protocol to obtain an encrypted-encapsulated control command, and transmit, through the fourth network interface, the encrypted-encapsulated control command to the first network interface; and
the audio and video data acquisition device is further configured to decrypt and de-encapsulate the encrypted-encapsulated control command to obtain a decrypted and de-encapsulated control command, and respond to the decrypted and de-encapsulated control command.

10. The system according to claim 7, wherein the bridge device is further provided with an Ethernet interface; the local video conference host is connected to a USB network card through the first USB interface, and the USB network card is electrically connected to the Ethernet interface;
the local video conference host is further configured to transmit, through the USB network card, a network-format encrypted control command to the Ethernet interface;
the bridge device is further configured to transmit, through the fourth network interface, the network-format encrypted control command to the audio and video data acquisition device; and
the audio and video data acquisition device is configured to decrypt and de-encapsulate the network-format encrypted control command to obtain a decrypted and de-encapsulated control command, and respond to the decrypted and de-encapsulated control command.

11. A video conference data transmission method for a video conference data transmission system, wherein the video conference data transmission system comprises one or more audio and video data acquisition devices and a local video conference host, each of the audio and video data acquisition devices is provided with one or more first network interfaces, each of the first network interfaces is electrically connected to the local video conference host, and the local video conference host is provided with a second network interface, and wherein the method comprises:
acquiring, by each of the audio and video data acquisition devices, audio and video data;
transmitting, by the audio and video data acquisition device through the first network interface, the audio and video data to the local video conference host, wherein the first network interface is configured to use an encrypted network protocol for data transmission; and
transmitting, by the local video conference host through the second network interface, the audio and video data to a remote video conference host, wherein the second network interface is configured to use a wide area network protocol for data transmission.

12. The method according to claim 11, wherein the local video conference host is further provided with one or more third network interfaces, each of the third network interfaces is configured to use the encrypted network protocol for data transmission, and the third network interface is configured to be connected to a respective first network interface through a network cable; and
wherein the transmitting, by the audio and video data acquisition device through the first network interface, the audio and video data to the local video conference host comprises:
performing, by the audio and video data acquisition device through the encrypted network protocol of the first network interface, encrypted encapsulation on the audio and video data to obtain encrypted-encapsulated audio and video data; and
transmitting, by the audio and video data acquisition device through the first network interface, the encrypted-encapsulated audio and video data to the third network interface.

13. The method according to claim 12, wherein the transmitting, by the local video conference host through the second network interface, the audio and video data to the remote video conference host comprises:
decrypting and de-encapsulating, by the local video conference host, the encrypted-encapsulated audio and video data by using a decryption and de-encapsulation mode corresponding to the encrypted network protocol, and transmitting, by the local video conference host through the second network interface, decrypted and de-encapsulated audio and video data to the remote video conference host.

14. The method according to claim 12, wherein the audio and video data acquisition devices comprise a plurality of video acquisition devices and a plurality of audio acquisition devices, one of the video acquisition devices is designated as a target video acquisition device, and one of the audio acquisition devices is designated as a target audio acquisition device; the video acquisition devices are cascaded through the first network interfaces of the video acquisition devices, and the audio acquisition devices are cascaded through the first network interfaces of the audio acquisition devices;
wherein the transmitting, by the audio and video data acquisition device through the first network interface, the encrypted-encapsulated audio and video data to the third network interface comprises:
obtaining, by the target video acquisition device through the cascaded video acquisition devices, encrypted-encapsulated video data of the cascaded video acquisition devices, and transmitting, through a first network interface of the target video acquisition device, obtained encrypted-encapsulated video data to a respective third network interface; and
obtaining, by the target audio acquisition device through the cascaded audio acquisition devices, encrypted-encapsulated audio data of the cascaded audio acquisition devices, and transmitting, through a first network interface of the target audio acquisition device, obtained encrypted-encapsulated audio data to a respective third network interface.

15. The method according to claim 12, wherein the video conference data transmission system comprises a plurality of audio and video data acquisition devices; the video conference data transmission system further comprises an audio and video data processing device, the audio and video data processing device is provided with a plurality of fifth network interfaces, and the fifth network interfaces are configured to use the encrypted network protocol for data transmission;
wherein the transmitting, by the audio and video data acquisition device through the first network interface, the encrypted-encapsulated audio and video data to the third network interface comprises:
transmitting, by each of the audio and video data acquisition devices through the first network interface, the encrypted-encapsulated audio and video data to a respective fifth network interface;
performing, by the audio and video data processing device, data processing on the received encrypted-encapsulated audio and video data to obtain audio and video data after data processing; and
transmitting, by the audio and video data processing device through a respective one of the fifth network interfaces, the audio and video data after data processing to the third network interface.

16. The method according to claim 15, wherein the audio and video data processing device is an Ethernet switch or an audio and video hub device.

17. The method according to claim 11, wherein the video conference data transmission system further comprises a bridge device, and the bridge device is provided with a fourth network interface; the fourth network interface is configured to use the encrypted network protocol for data transmission, and the fourth network interface is connected to the first network interface of a respective audio and video data acquisition device through a network cable; the local video conference host is provided with a first USB interface, the bridge device is provided with a second USB interface, and the first USB interface and the second USB interface are configured to be connected through a USB cable; and
wherein the transmitting, by the audio and video data acquisition device through the first network interface, the audio and video data to the local video conference host comprises:
performing, by the audio and video data acquisition device, encrypted encapsulation on the audio and video data through the encrypted network protocol of the first network interface, and transmitting, through the first network interface, encrypted-encapsulated audio and video data to the fourth network interface; and
re-encapsulating, by the bridge device, the encrypted-encapsulated audio and video data through a USB protocol to obtain USB-protocol-encapsulated encrypted audio and video data, and transmitting, through the second USB interface, the USB-protocol-encapsulated encrypted audio and video data to the first USB interface.

18. The method according to claim 17, wherein the transmitting, by the local video conference host through the second network interface, the audio and video data to the remote video conference host comprises:
decrypting and de-encapsulating, by the local video conference host, the USB-protocol-encapsulated encrypted audio and video data, and transmitting, through the second network interface, decrypted and de-encapsulated audio and video data to the remote video conference host.

19. The method according to claim 17, further comprising:
transmitting, by the local video conference host through the first USB interface, a USB-protocol-encapsulated control command to the second USB interface;
re-encapsulating, by the bridge device, the USB-protocol-encapsulated control command through the encrypted network protocol to obtain an encrypted-encapsulated control command, and transmitting, through the fourth network interface, the encrypted-encapsulated control command to the first network interface; and
decrypting and de-encapsulating, by the audio and video data acquisition device, the encrypted-encapsulated control command to obtain a decrypted and de-encapsulated control command, and responding to the decrypted and de-encapsulated control command.

20. The method according to claim 17, wherein the bridge device is further provided with an Ethernet interface; the local video conference host is connected to a USB network card through the first USB interface, and the USB network card is electrically connected to the Ethernet interface;
wherein the method further comprises:
transmitting, by the local video conference host through the USB network card, a network-format encrypted control command to the Ethernet interface;
transmitting, by the bridge device through the fourth network interface, the network-format encrypted control command to the audio and video data acquisition device; and
decrypting and de-encapsulating, by the audio and video data acquisition device, the network-format encrypted control command to obtain a decrypted and de-encapsulated control command, and responding to the decrypted and de-encapsulated control command.
